(19) United States
(12) Patent Application Publication
(10) Pub. No.: US 2010/0291281 A1
(43) Pub. Date: Nov. 18, 2010

(54) Diet food using pork skin

(76) Inventor: Sang In Lee, GangSeo-Gu (KR)

Correspondence Address: COOPER & DUNHAM, LLP, 30 Rockefeller Plaza, 20th Floor, NEW YORK, NY, 10112, US

(21) Appl. No.: 12/454,311

(22) Filed: May 14, 2009

(51) Int. Cl. A23L 1/312; A23L 1/01; A23L 1/0562

(52) U.S. Cl. 426/574; 426/510; 426/417

(57) ABSTRACT

A process for making a diet food product, includes the stage of putting a certain amount of treated pork skin into an s-cutter and pouring in boiled water with 100:400 ratio, then by opening the steam valve and applying steam into the pot for 20-30 minute then, in order to reduce a fat portion, pour the water and apply the steam again for 30˜60 minute with cover closed, then the temperature and the pressure increase and collected at the bottom of the pot, cutting the boiled pork skin, applying 0.67% of salt to produce a gel and making a gel that is sticky, to eliminate the smell, add ginger, garlic, ginseng, soju and then fix the form.

### BACKGROUND OF THE DISCLOSURE

1. Technical Field

The present invention is about the recipe of diet food product using pork skin, in detail, by not using the sugar, protein or cooking oil, and uses certain amount of table salt, we can produce the diet materials such as cookie, jelly, noodle or the snacks.

2. Background Art

Generally pork skin were fried or barbequed. However these days it is used as diet snack. It is because pork skin barely has protein and in order to produce energy the body has to use stored fat, it is used as a diet food.

The problem is in previous inventions which also used the pork skin. However they are all just fried, thus it can't be turned into various kind of food such as cookie, snack, noodle or jelly.

### SUMMARY

In order to solve problems associated with the background art, the present disclosure uses pork skin which barely consists protein, and combine this with table salt and water to produce cookie, jelly, noodle and fired snack like foods and by using this, it produce organic diet food in various form.

This can be done by boiling, fixing form or frying the pork skin.

The pork skin barely has protein and in order to produce energy the body has to use stored fat, it is used as a diet food. Thus it increases the appetite and responds to various kinds of food.

A process for making a diet food product, includes the stage of putting a certain amount of treated pork skin into an s-cutter and pouring in boiled water with 100:400 ratio, then by opening the steam valve and applying steam into the pot for 20-30 minute then, in order to reduce a fat portion, pour the water and apply the steam again for 30˜60 minute with cover closed, then the temperature and the pressure increase and collected at the bottom of the pot, cutting the boiled pork skin, applying 0.67% of salt to produce a gel and making a gel that is sticky, to eliminate the smell, add ginger, garlic, ginseng, soju and then fix the form.

### DETAILED DESCRIPTION

The present disclosure has pork skin as its main ingredient and by adding certain amount of salt and water into it, we produce cookie, snack, jelly and noodle like food.

Pork skin mainly consists of collagen, thus we would like to use ‘collagen’ for rest of food's name mentioned below.

The detailed explanation will be related to the ‘examples of collagen cookie, bean cookie, snack, bean snack, noodle, bean noodle, jelly and collagen jelly’.

Of course, we can present more various examples, however the present invention would be explained in examples herein.

The present invention consist pork skin, bean, water, ginger, garlic, onion, shrimp, refined rice wine, soybean paste, soju to eliminate the smell. Moreover, the manufacturing way of material would be eliminating the solid fat from the skin with its hair and wash well with water. The bean should be eatable. The bean can be used instead of oil. The water used should be drinking water. The salt can be glutamine.

The spice can be controlled to one's favor. The speedy carter that cuts pork skin can be used as the inventor's invention which is s-carter that consist steam pot and high speed carter. The s-shaped blade would be attached with motor.

It cuts and steams it at the same time with 2, 4 or 6 blades.

The original material of collagen cookie, collagen biscuit, collagen snack collagen jelly or noodle consist 66% of pork skin 0.67% of salt and 33.33% of water.

The fat can be reduced and the smell can be eliminated by putting the certain amount of treated pork skin into the s-cutter and pour in the boiled water with 100:400 ratio. Then by opening the steam valve and apply the steam into the pot for 20-30 minute. In order to reduce the fat portion, pour the water and apply the steam again for 30˜60 minute with cover closed. Then the temperature and the pressure increase and collected at the bottom of the pot.

Moreover to the saturated pork skin, pour the boiled water into the s-cutter to 33.33% of portion and boil 10˜20 minute with steam applied.

By cutting the boiled pork skin, apply 0.67% of salt and manufacture the ‘pork skin gel’ that is little smelly and sticky.

In order to eliminate the smell, apply ginger, onion, garlic and soju and manufacture ‘pork skin gel’.

In addition operate the s-cutter after applying the certain amount of salt and spice. Open the lid and check the jelly and after cutting it, cover the lid and by exceeding the pressured air transfer it to the forming stage.

In manufacturing the diet food with various examples above, the original material of collagen bean, cookie, bean biscuit, bean snack, bean jelly, bean noodle consist 49.44% of pork skin, 11.11% of bean protein, 0.36% of salt, 38.89% of water.

Put the certain amount of treated pork skin into the s-cutter and pour in the boiled water with 100:400 ratios. Then by opening the steam valve and apply the steam into the pot for 20-30 minute. In order to reduce the fat portion, pour the water and apply the steam again for 30˜60 minute with cover closed. Then the temperature and the pressure increase and collected at the bottom of the pot.

Then cut the pork portion with the cutter

By cutting the boiled pork skin, apply 0.56% of salt and 11.11% of bean protein

In addition operate he s-cutter after applying the certain amount of salt and spice. Open the lid and check the jelly and after cutting it, cover the lid and by exceeding the pressured air transfer it to the forming stage.

### The Example of Pork Skin Cracker

1. It is better to use the pork skin only, however in order to carry out better cutting process; boil the pork skin which would be sanitized and transformable. It shortens the time of whole stages.
2. After reforming the structure, by using the cover, bakes it until it becomes brown and supply special, unusual taste.
3. Because it evaporates the water, it can be very crunchy.
4. It is possible to keep it without using too much money on it.
5. We tried not to use artificial taste but in order to spice it, we added ginger and spice and salt.

### Example of Pork Skin Snack

Put the certain amount of treated pork skin into the s-cutter and pour in the boiled water with 100:400 ratios. Then by opening the steam valve and apply the steam into the pot for 20-30 minute. In order to reduce the fat portion, pour the water of 33.33% and apply the steam again for 30˜60 minute with cover closed. Then the temperature and the pressure increase and collected at the bottom of the pot.

Then cut the pork portion with the cutter By cutting the boiled pork skin, apply 0.67% of salt to produce the gel. Moreover manufacturing gel that is sticky, to eliminate the smell, add ginger, garlic, ginseng, soju and then fix the form.

Then dry it in 60° C.-90° C. and fry it at temperature of 150° C.-180° C. to make snack.

### Example of Pork Snack Noodle

Put the certain amount of treated pork skin 66% into the s-cutter and pour in the boiled water with 100:400 ratios. Then by opening the steam valve and apply the steam into the pot for 20-30 minute. In order to reduce the fat portion, pour the water of 33.33% and apply the steam again for 30˜60 minute with cover closed. Then the temperature and the pressure increase and collected at the bottom of the pot.

Then cut the pork portion with the cutter By cutting the boiled pork skin, apply 0.67% of salt to produce the gel. Moreover manufacturing gel that is sticky, to eliminate the smell, add ginger, garlic, ginseng, soju and then fix the form.

Then when it is forming its structure by putting the nozzle on the device and makes the noodle and cools it in short period.

### Example of Pork Skin Jello

Put the certain amount of treated pork skin 66% into the s-cutter and pour in the boiled water with 100:400 ratios. Then by opening the steam valve and apply the steam into the pot for 20-30 minute. In order to reduce the fat portion, pour the water of 33.33% and apply the steam again for 30˜60 minute with cover closed. Then the temperature and the pressure increase and collected at the bottom of the pot.

Then cut the pork portion with the cutter By cutting the boiled pork skin, apply 0.67% of salt to produce the gel. Moreover manufacturing gel that is sticky, to eliminate the smell, add ginger, garlic, ginseng, soju and then fix the form.

Then put it in the tofu shaping device and fix it to make pork skin jelly.

### Example of Collagen Bean Cracker

Put the certain amount of treated pork skin 49.44% into the s-cutter and pour in the boiled water with 100:400 ratios. Then by opening the steam valve and apply the steam into the pot for 20-30 minute. In order to reduce the fat portion, pour the water of 38.89% and apply the steam again for 30˜60 minute with cover closed. Then the temperature and the pressure increase and collected at the bottom of the pot.

Then cut the pork portion with the cutter By cutting the boiled pork skin, apply 0.56% of salt and bean protein of 11.11% to produce the gel. Moreover manufacturing gel that is sticky, to eliminate the smell, add ginger, garlic, ginseng, soju and then fix the form.

Fix the form and then fry it then 125° C.-135° C. and dry it and cool it in the atmosphere.

### Example of Collagen Bean Snack

Put the certain amount of treated pork skin 49.44% into the s-cutter and pour in the boiled water with 100:400 ratios. Then by opening the steam valve and apply the steam into the pot for 20-30 minute. In order to reduce the fat portion, pour the water of 38.89% and apply the steam again for 30˜60 minute with cover closed. Then the temperature and the pressure increase and collected at the bottom of the pot.

Then cut the pork portion with the cutter By cutting the boiled pork skin, apply 0.56% of salt and bean protein of 11.11% to produce the gel. Moreover manufacturing gel that is sticky, to eliminate the smell, add ginger, garlic, ginseng, soju and then fix the form.

Fix the form and dry it for the 1sst stage under 60° C. to 90° C. and fry it under 150° C.-180° C. Then cool it to make soft and crack snack.

The advantage of collage snack and bean snack that them individual attracts the appetite. Moreover, compare to any other protein snack products, it is more juicy and we can very its form to stick, ring, cube or cylinder.

In addition since are didn't use sugar or any other sugar like product, the taste doesn't remain for long.

### Example of Collagen Bean Noodle

Put the certain amount of treated pork skin 66% into the s-cutter and pour in the boiled water with 100:400 ratios. Then by opening the steam valve and apply the steam into the pot for 20-30 minute. In order to reduce the fat portion, pour the water of 33.33% and apply the steam again for 30˜60 minute with cover closed. Then the temperature and the pressure increase and collected at the bottom of the pot.

Then cut the pork portion with the cutter By cutting the boiled pork skin, apply 0.67% of salt to produce the gel. Moreover manufacturing gel that is sticky, to eliminate the smell, add ginger, garlic, ginseng, soju and then fix the form.

The good thing about collagen noodle and bean noodle above is that, if you add sauce on it, it can be more tasty and useful than snacks.

### Example of Collagen Bean Jelly

Put the certain amount of treated pork skin 66% into the s-cutter and pour in the boiled water with 100:400 ratios. Then by opening the steam valve and apply the steam into the pot for 20-30 minute. In order to reduce the fat portion, pour the water of 33.33% and apply the steam again for 30˜60 minute with cover closed. Then the temperature and the pressure increase and collected at the bottom of the pot.

Then cut the pork portion with the cutter By cutting the boiled pork skin, apply 0.67% of salt to produce the gel. Moreover manufacturing gel that is sticky, to eliminate the smell, add ginger, garlic, ginseng, soju and then fix the form.

Then put it in the tofu shaping device and fix it to make pork skin jelly. The collagen jelly and collagen bean jelly can be cut with knife and add to the spice.

It can be better if you add the bean materials since it can accentuate its original taste.

This bean material is good to be added to any other food for example the pork skin bean jelly with 20%-50% of bean material in it can be mixed.

It can be product after cooling and drying it.

What is claimed is:

1. A process for making a diet food product, comprising the stage of putting a certain amount of treated pork skin into an s-cutter and pouring in boiled water with 100:400 ratio, then by opening the steam valve and applying steam into the pot for 20-30 minute then, in order to reduce a fat portion, pour the water and apply the steam again for 30˜60 minute with cover closed, then the temperature and the pressure increase and collected at the bottom of the pot, cutting the boiled pork skin, applying 0.67% of salt to produce a gel and making a gel that is sticky, to eliminate the smell, add ginger, garlic, ginseng, soju and then fix the form.

2. The process for making the diet food product as recited in claim 1, further comprising applying 0.67% of salt to produce the gel, making gel that is sticky, to eliminate the smell, add ginger, garlic, ginseng, soju and then fix the form.

3. A process for making a diet food product comprising: reducing fat and eliminating smell by putting a certain amount of treated pork skin into an s-cutter and pouring in boiled water with 100:400 ratio, opening a steam valve and applying steam into the pot for 20-30 minute then, in order to reduce fat portion, pour the water and apply the steam again for 30˜60 minute with cover closed, allowing the temperature and the pressure to increase and be collected at the bottom of the pot, to the saturated pork skin, pour the boiled water into the s-cutter to 38.89% of portion and boil 10˜20 minute with steam applied, then cut the pork portion with the cutter, then by cutting the boiled pork skin, apply 0.56% of salt and 11.11% of bean protein

4. The process for making the diet food product as recited in claim 1, further comprising fixing the form and then fry it then 125° C.-135° C. and dry it and cool it in the atmosphere.

5. The process for making the diet food product as recited in claim 1, further comprising fixing the form and dry it for the first stage under 60° C. to 90° C. and fry it under 150° C.-180° C. Then cool it to make soft and crack snack.

6. The process for making the diet food product as recited in claim 1, wherein after forming its structure by putting the nozzle on the device and makes the noodle and cools it in short period.

7. The process for making a diet food product as recited in claim 1, further comprising putting it in a tofu shaping device and fix it to make pork skin jelly, wherein the collagen jelly and collagen bean jelly can be cut with knife and add to the spice.

8. The process for making a diet food product as recited in claim 3, further comprising using the bean pork skin gel, fix the form and dry it for the first stage under 60° C. to 90° C. and fry it under 125° C.-135° C. Then cool it to make soft and crack snack.

9. The process for making a diet food product as recited in claim 3, further comprising using the bean pork skin gel, fix the form and dry it for the first stage under 60° C. to 90° C. and fry it under 150° C.-180° C. Then cool it to make soft and crack snack.

10. The process for making a diet food product as recited in claim 3, further comprising using the bean pork skin gel, after forming its structure by putting the nozzle on the device and making the noodle and cools it in short period.

11. The process for making a diet food product as recited in claim 3, further comprising using the bean pork skin gel, put it in the tofu shaping device and fix it to make pork skin jelly, wherein the collagen jelly and collagen bean jelly can be cut with knife and add to the spice.

12. A process for making a diet food product wherein spice can be controlled to one's favor, a speedy cutter that cuts pork skin can be used as an s-carter that consists of a steam pot and high speed cutter, the s-shaped blade being attached with a motor, wherein the cutter cuts and steams it at the same time using 2, 4 or 6 blades.

13. The process for making the diet food product as recited in claim 2, further comprising fixing the form and then fry it then 125° C.-135° C. and dry it and cool it in the atmosphere.

14. The process for making the diet food product as recited in claim 2, further comprising fixing the form and dry it for the first stage under 60° C. to 90° C. and fry it under 150° C.-180° C. Then cool it to make soft and crack snack.

15. The process for making the diet food product as recited in claim 2, wherein after forming its structure by putting the nozzle on the device and makes the noodle and cools it in short period.

16. The process for making a diet food product as recited in claim 2, further comprising putting it in a tofu shaping device and fix it to make pork skin jelly, wherein the collagen jelly and collagen bean jelly can be cut with knife and add to the spice.
